(19) United States
(12) Patent Application Publication
(10) Pub. No.: US 2009/0141705 A1
(43) Pub. Date: Jun. 4, 2009

(54) Device and method for address-mapping

(75) Inventor: Volker Mosker, Isselburg (DE)

Correspondence Address: STAAS & HALSEY LLP, SUITE 700, 1201 NEW YORK AVENUE, N.W., WASHINGTON, DC, 20005, US

(73) Assignee: Siemens Home and Office Comunication Devices GmbH & Co., KG, Munich (DE)

(21) Appl. No.: 11/991,256

(22) PCT Filed: Jun. 21, 2006
(86) PCT No.: PCT/EP2006/005968

§ 371 Date: Feb. 29, 2008

(51) Int. Cl. H04L 12/56; H04L 12/66

(52) U.S. Cl. 370/352; 370/389

(57) ABSTRACT

To perform address mapping, a configuration client determines port numbers required for a network service and a network address conversion unit converts external network addresses into internal network addresses and vice versa. A configuration server requests required port numbers from the network address conversion unit which directly provides the network service with an external network address with the required port number. A device located in an internal address domain can thus be allocated a unique external network address.

### BACKGROUND

Described below is an apparatus and a method for address mapping and in particular to an apparatus and a method for address mapping of devices in a home network to an external IP address space.

FIG. 1 shows a simplified block diagram of a telecommunications system in which an internal network HN such as a home network is connected to an external network N such as the Internet. According to FIG. 1, for example, a telecommunications terminal TE can be connected using so-called VoIP (Voice over IP) functionality to a network node or, more specifically, a router R, and the latter can be linked e.g. via a DSL line (digital subscriber line) to an external network N which is preferably a packet-switched network. In this way IP (Internet Protocol) telephony, for example, can be provided inexpensively also via packet-switched networks.

Such internal networks or, more specifically, home networks HN can be connected to the Internet N via so-called NAT (network address translation) network nodes or, more specifically, routers R, network nodes R of this kind having network address (port) translation (NA(P)T) capability.

Network address translation is a method whereby, for example, an IP address is replaced by another in a data packet. Such network address translation is necessary mainly because IP addresses are in increasingly short supply, and internal IP addresses are therefore employed in a home network. To ensure that the devices in the internal network HN can nevertheless communicate with the external network or, more specifically, the Internet N, the internal addresses must be translated, i.e. converted, into external addresses. In the case of outgoing data packets, the internal source IP address is replaced by an as yet unused external IP address, the network address translation unit noting this conversion. In the case of incoming data packets, it can then be determined, on the basis of the destination IP address and the table entry, which device within the home network HN had requested the data packets.

However, the disadvantage with this system is that, on the one hand, connections always have to be initiated internally, i.e. by the home network HN, so that the network node or, more specifically, the router R can identify the internal communications partner. Moreover, the internal network users or rather devices do not know the external IP address of the home network HN, the internal network users in some cases not even knowing the externally used port numbers.

To obviate these disadvantages, extremely complex concepts are currently in use. For example “ALGs” (application layer gateways) scan the data traffic in the network node or, more specifically, the router R, classifying the data traffic on the basis of application-specific features and manipulating it accordingly by interchanging e.g. IP addresses and port numbers.

In addition, so-called “port forwarding/virtual server” can be used in which a user can define static routes in the network node R in order to allow externally initiated communication. Here, however, a user has to be very familiar with IP addresses and port numbers.

Finally so-called “port triggering” should be mentioned whereby, on the basis of application characteristics which, however, may change and are unknown to new applications when a system is sold, time-limited static routes for outgoing connections are enabled for incoming connections. However, a unique assignment again cannot be maintained, for which reason encryption methods in particular are subject to major problems at network and transport level.

### SUMMARY

An aspect is therefore to provide an apparatus and a method for address mapping with which devices within a home network can be addressed directly from the outside.

In particular, by using a configuration client to request port numbers intended for a network service and a configuration server to request the required port numbers from a network address translation unit, the network address translation unit assigning an external network address with the requested port number directly to the network service, direct addressing of devices within a home network can, for the first time, be carried out without conventional address translation. In this way particular devices which need to be externally accessible only via a limited number of port numbers, such as VoIP telephones, web cameras, dedicated web servers, etc., can be mapped directly in an external IP address space.

Preferably the configuration client is a DHCP (dynamic host configuration protocol) client and the configuration server is a DHCP server. Such a protocol is available for a large number of network nodes and in particular for network address translation units, so that extremely inexpensive implementation is possible.

If the requested port number is unavailable, the network address translation unit can preferably propose an alternative port number, thereby enabling configuration to be considerably simplified.

For example, the network address translation unit and the configuration server can be implemented in a network node or, more specifically, a router, and the configuration client and network service can be implemented in a telecommunications terminal such as a telephone. In this way any devices of a home network can be mapped directly to the external IP address space by a network node.

Alternatively, the functionalities of the network address translation unit, configuration server, configuration client and network service can also be implemented in a single telecommunications unit, thereby providing a so-called standalone solution of the system which can be directly connected to an external network.

Although a VoIP service for implementing IP telephony is a preferred option as a network service, in principle web cameras, web servers and the like are also conceivable.

In respect of the method for address mapping, first at least one port number for a network service is requested, the required port number is then requested from a network address translation unit, the requested port number is then confirmed or an alternative port number is issued, the confirmed or alternative port number is then accepted or declined by the network service and finally incoming data traffic is through-connected in the network address translation unit to the network service if the port number was accepted.

### BRIEF DESCRIPTION OF THE DRAWINGS

These and other aspects and advantages will become more apparent and more readily appreciated from the following description of exemplary embodiments, taken in conjunction with the accompanying drawings of which:

FIG. 1 is a simplified block diagram to illustrate a telecommunications system comprising a home network and an external network;

FIG. 2 is a simplified block diagram to illustrate a home network comprising a telecommunications terminal and a network node;

FIG. 3A is a sequence diagram according to a first exemplary embodiment;

FIG. 3B is a sequence diagram according to a second exemplary embodiment;

FIG. 4A is a simplified representation of an external address space of a network node prior to through-connection of the data traffic;

FIG. 4B is a simplified representation of the external address space after the through-connection of the data traffic; and

FIG. 5 is a flowchart illustrating the address mapping method.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

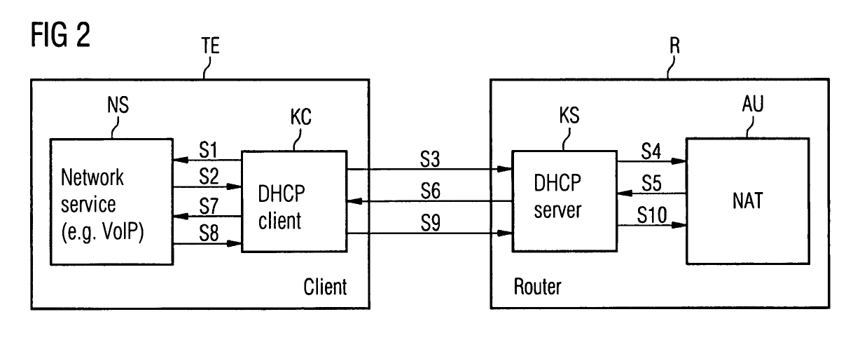

The simplified block diagram in FIG. 2 illustrates an internal network or, more specifically, a home network HN comprising a network node or, more specifically, a router R and, connected thereto, a telecommunications terminal TE such as an IP telephone.

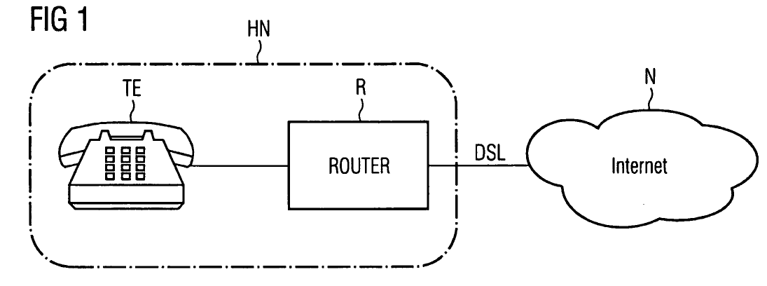

The network node R has a network address translation (NAT) unit AU which translates, i.e. converts, an external network address into an internal network address and, in the reverse direction, converts an internal network address into an external network address. As shown in FIG. 1, the network node or, more specifically, router R can be connected e.g. via a DSL line to a packet-switching network N such as the Internet.

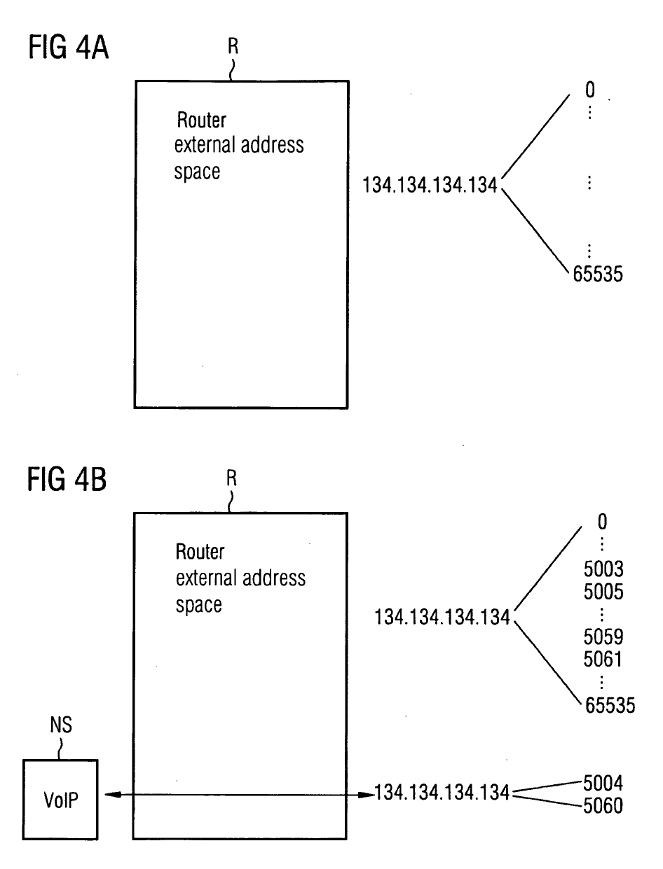

FIG. 4A shows the external address space of the network node R, the external network address, e.g. IP address (134.134.134 in the example) which additionally has port numbers 0 to 65535 available. As described herein, from this external address space the port numbers 5004 and 5060 shall now be assigned to a network service NS such as a VoIP (Voice over IP) service, for direct addressing.

As shown in FIG. 2, for this purpose the network node R not only has the network address translation unit AU but also a configuration server KS for configuring the network address translation unit AU. The network node R or, more specifically, its configuration server KS is connected via an internal data line such as a LAN (Local Area Network) to a telecommunications terminal TE or, more specifically, its configuration client KC. The telecommunications terminal TE additionally has a network service NS which can in turn be addressed by the configuration client KC. The network service NS can be a VoIP (Voice over IP) service for implementing an IP telephone device. The network service NS can be addressed here via an internal network address of the internal network HN.

To implement a network address or more specifically an external IP address directly assigned to the network service NS, the configuration client KC can first request the network service NS for at least one port number intended for the network service NS. This at least one port number requested from the network service NS is now communicated from the configuration client KC to the configuration server KS, which for its part requests the at least one required port number from the network address translation unit AU, the network address translation unit AU finally directly assigning its network address with the at least one requested port number to the network service NS and therefore enabling through-connection of data traffic as far as the network service NS. Address translation or conversion normally carried out in the network address translation unit AU no longer takes place in this context.

The network node or, more specifically, router R address space present after a configuration of this kind is shown in FIG. 4B in which, for the port numbers 5004 and 5060 requested from the network service NS, the external network addresses 134.134.134.134:5004 and 134.134.134.134:5060 have been reserved for the network service NS, these being directly through-connected to its internal addresses. In the remaining external address space of the network node R, the port numbers 5004 and 5060 are now missing, for which reason only the port numbers 0 to 5003, 5005 to 5059 and 5061 to 65535 are assigned to the external IP address 134.134.134.134 of the network node R.

Optionally, the port numbers usually requested from the network service NS can also be already predefined, thereby eliminating a corresponding request. For example, the desired port numbers can be present in the configuration client KC or in the configuration server KS.

According to FIG. 2, the configuration client KC is preferably a DHCP client for executing the so-called “dynamic host configuration protocol”, while the configuration server KS is an associated DHCP server in the network node R. This protocol used particularly for the Internet is present anyway in a large number of telecommunications terminals TE and/or network nodes R, which means that the method described herein can be implemented in a particularly simple and inexpensive manner, the DHCP being used in particular to allocate IP addresses automatically, thereby simplifying IP network management.

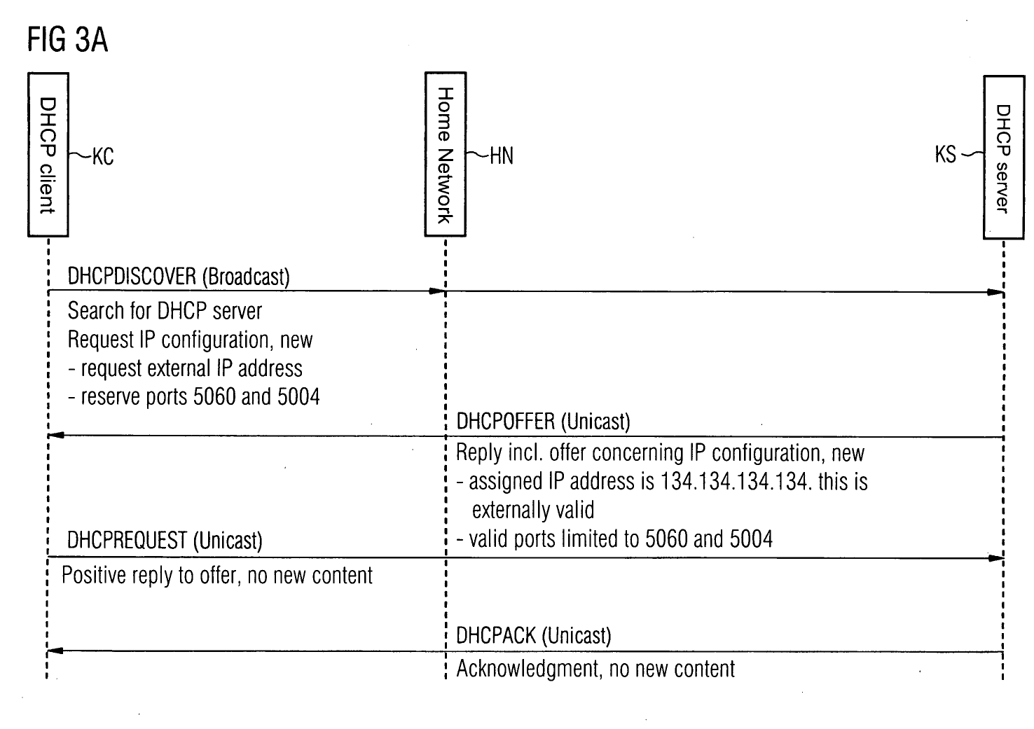

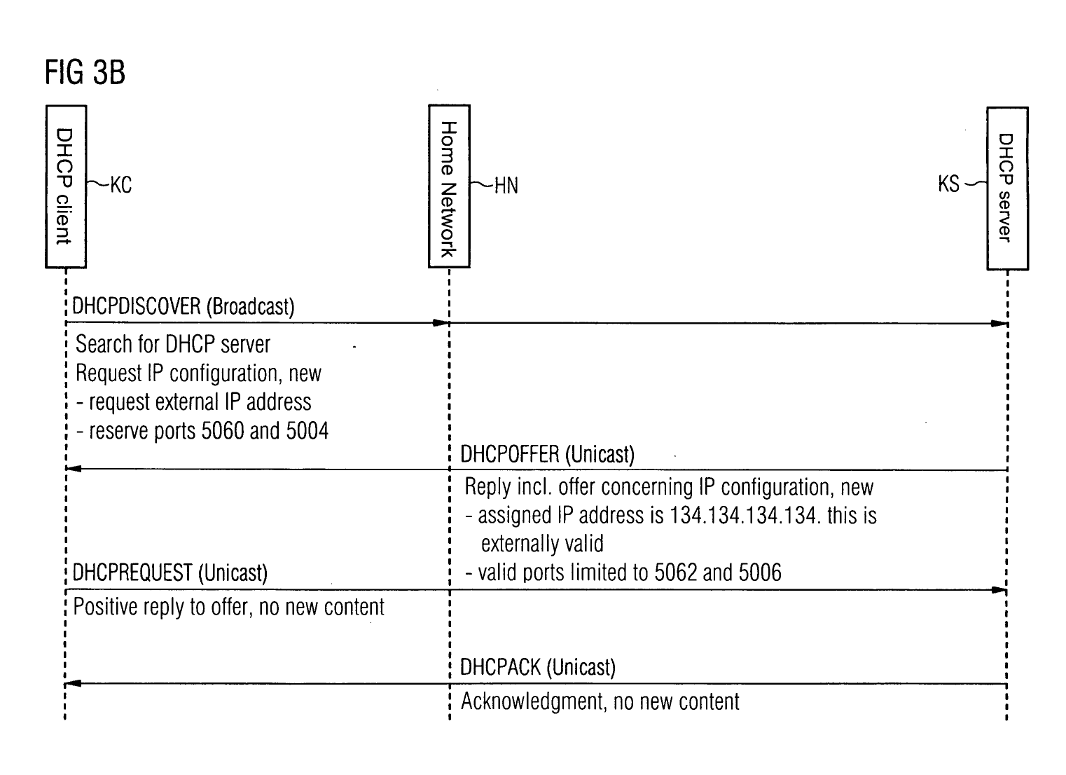

FIG. 3A shows a simplified representation of a sequence diagram, the configuration client KC being a DHCP client of this kind and the configuration server KS a DHCP server of this kind. The network service NS is e.g. a VoIP service for implementing an IP telephone, the network node R in turn having the external network address or, more specifically, IP address 134.134.134.134.

As shown in FIG. 3A, an IP configuration request is first made by the DHCP client KC via the broadcast message “DHCPDISCOVER” and a suitable DHCP server KS is searched for. More precisely, the external IP address of the system is requested and port reservation for e.g. the port numbers 5060 and 5004 which are normally to be allocated to the VoIP service is carried out. This request is responded to by the DHCP server KS with a unicast message “DHCPOFFER”, the assigned IP address “134.134.134.134” being communicated as an externally valid network address and the ports being limited to the desired port numbers 5060 and 5004.

The DHCP client KC responds to this offer via unicast message “DHCPREQUEST”, no new content being communicated. The DHCP server KS finally acknowledges this positive response via unicast message “DHCPACK”, again no new content being communicated. In this way an offered port number configuration can be confirmed by the configuration client KC to the configuration server KS.

FIG. 3B now shows a simplified representation of a sequence diagram according to a second example in which it is not the port numbers desired by the network service or configuration client KC that are proposed at the server end, but alternative port numbers, and these are accepted by the configuration client.

According to FIG. 3B, a suitable DHCP server is again searched for in the home network via a broadcast message “DHCPDISCOVER” and an IP configuration request is initiated, the external IP address being inquired about and port reservation for e.g. the port numbers 5060 and 5004 being carried out. For the case that the network address translation unit (not shown) has already allocated the desired port numbers 5060 and 5004 or these are unavailable, the network address translation unit AU can now propose alternative port numbers, the DHCP server KS communicating in a unicast message “DHCPOFFER” that the assigned external IP address is 134.134.134.134 and is also externally valid, but the ports being limited to the alternatively proposed port numbers 5062 and 5006.

In its unicast message “DHCPREQUEST”, the DHCP client KC can now respond positively to this offer or rather this reply of the DHCP server KS, provided it is in agreement with the alternatively proposed port numbers 5062 and 5006, no new content being communicated. A positive reply of this kind from the DHCP server KS is acknowledged with the unicast message “DHCPACK”, again no new content being communicated. In this way, assignment of an external network address to a device or network service NS within a home network HN can be carried out in a simple manner using a DHCP environment.

Consequently, the disadvantages of the conventional NAT concept are obviated in that particular devices within the home network, which need to be accessible externally only via a limited number of ports or more specifically port numbers, such as VoIP telephones, web cameras, web servers, etc., can be mapped directly to the external IP address space.

In the case of a DHCP environment, this is implemented by an extended DHCPREQUEST which, in addition to the currently usual parameters, also contains an inquiry concerning the externally valid IP address of the system, a listing of the port numbers via which the device must be accessible externally, and the port numbers which the device uses for an outgoing connection. The device thereby asks for assignment of the IP address and desired port numbers, the network node R with its network address translation unit AU checking the request and allocating the required parameters to the device unless the ports or, more specifically, port numbers have already been assigned to another device.

If the parameters have already been assigned, the device receives a negative reply and can make a new “request” which can now contain other port numbers. As described above, the negative reply may also contain an alternative proposal with other port numbers.

In principle the concept can also be effected for any port numbers by explicit negotiation of the port numbers whereby the device does not specify port numbers, but only how many ports are required. In order to avoid multiple assignment of port numbers, the network node R or, more specifically, its network address translation unit AU must delete the reserved addresses or port numbers for the device from its list of available port numbers or rather mark them as unavailable.

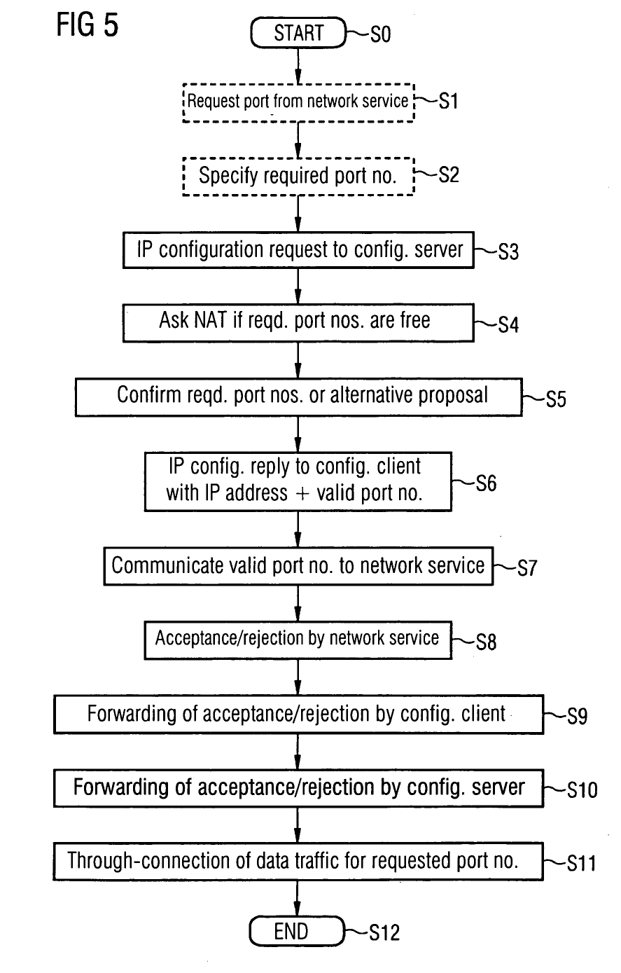

The method for address mapping will now be described, the arrows S1 to S10 in FIG. 2 representing corresponding steps as shown in FIG. 5. FIG. 5 accordingly shows a flowchart illustrating the address mapping method.

After startup in step S0, in a step S1 the DHCP client KC first asks the network service NS which ports or more specifically port numbers are required or desired. This optional step can also be omitted if the required ports or port numbers are already fixed in the DHCP client. For the case that they are not fixed in the DHCP client KC, in the likewise optional step S2 a reply in which the desired port numbers are specified can be sent by the network service NS to the DHCP client KC.

For the above described example of a VoIP service, e.g. the usual port numbers 5060 and 5004 are issued as desired port numbers. In a step S3, an IP configuration request is now made to the configuration server KS whereby the configuration client KC asks the configuration server KS to assign an external IP address and the desired port numbers 5060 and 5004.

In a step S4 this request is forwarded from the DHCP server KS to the network address translation unit AU, inquiring whether the requested ports or, more specifically, port numbers 5060 and 5004 are still free. In a step S5, a reply to this inquiry is sent from the network address translation unit AU to the DHCP server KS, positively confirming the desired port numbers if they are still freely available, or else a negative reply being issued. In the event of a negative reply, optionally one or more alternative port numbers still freely available for the external address space can be issued or proposed.

In step S6, an IP configuration reply is now sent from the DHCP server KS to the DHCP client KC specifying the network configuration and the port numbers reported as freely available by the network address translation unit AU.

In a step S7, these port numbers are forwarded or communicated from the configuration client KC to the network service NS, the network service NS being able, in a step S8, either to accept or decline the communicated port numbers, in which case it sends a negative response. In step S9, this positive or negative response from the DHCP client KC is forwarded to the configuration server KS.

If the port numbers have not been accepted by the network service, i.e. a rejection is present, the configuration client KC can initiate a new request according to step S1 or S3. If the port numbers have been accepted by the network service NS, these port numbers are reported by the configuration server KS to the network address translation unit AU as taken. In a step S11, the data traffic is then through-connected in the network address translation unit AU for the accepted port numbers and the port numbers are marked accordingly as no longer available. The method ends in a step S12.

The device or more specifically network service and network node or, more specifically, router R therefore configure their lists with available port numbers, which means that the device or, more specifically, the network service NS only uses the port numbers assigned to it for its communication and the network node R removes these port numbers from its list. In this way, each correspondingly configured internal device is given a unique external IP address.

If the configuration offer from the configuration server KS is unacceptable, the configuration client KC can send the message “DHCPDECLINE” to the configuration server KS, re-negotiation then taking place. The parameters such as port numbers can change again here.

It is also possible for the network service NS to decide to live with an only internally valid IP address, conventional address translation again having to be performed.

Although the method has been described above in terms of a VoIP service for implementing an IP telephone, it is not limited thereto and also encompasses in like manner web cameras or dedicated web servers as network services. In the same way, although the present method has been described in terms of a DHCP client and server as configuration client and server, it is not limited thereto and also encompasses in like manner alternative configuration clients and servers.

In addition, although a solution has been proposed above in which the telecommunications terminal is embodied separately from the network node in the home network, the system described herein is not limited thereto and also encompasses in like manner devices in which the network address translation unit, the configuration server, the configuration client and the network service are implemented in a terminal of a home network.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-14. (canceled)

15. An apparatus for address mapping, comprising
a network service unit addressable via an internal network address;
a configuration client determining at least one desired port number intended for said network service unit;
a network address translation unit translating in both directions between external network addresses and internal network addresses, including directly assigning an external network address with the at least one requested port number to said network service unit; and
a configuration server, coupled to said network service unit, said configuration client and said network address translation unit, requesting the at least one desired port number from said network address translation unit.

16. The apparatus as claimed in claim 15, wherein said configuration client is a dynamic host configuration protocol client and said configuration server is a dynamic host configuration protocol server.

17. The apparatus as claimed in claim 16, wherein, if the requested port number is unavailable, said network address translation unit issues an available alternative port number.

18. The apparatus as claimed in claim 17, wherein said network address translation unit and said configuration server are implemented in a network node and said configuration client and said network service unit are implemented in a telecommunications terminal of a home network.

19. The apparatus as claimed in claim 17, wherein said network address translation unit, said configuration server, said configuration client and said network service unit are implemented in a telecommunications terminal of a home network.

20. The apparatus as claimed in claim 19, wherein said network service unit is a Voice over Internet Protocol service unit.

21. A method for address mapping, comprising:
determining at least one port number desired for a network service;
requesting the at least one port number from a network address translation unit;
one of confirming the at least one port number and issuing an alternative port number;
one of accepting and declining, by the network service after said one of confirming and issuing, one of the at least one port number and the alternative port number; and
through-connecting incoming data traffic in the network address translation unit to the network service after acceptance of the one of the at least one port number and the alternative port number by the network service.

22. The method as claimed in claim 21, wherein said determining the at least one port number includes
sending a port number request to the network service;
issuing, by the network service, the one of the at least one port number and the alternative port number; and
sending, after said issuing, a configuration request from a configuration client to a configuration server for the one of the at least one port number and the alternative port number.

23. The method as claimed in claim 22, wherein said requesting includes checking availability of the at least one port number in a port number list of the network address translation unit.

24. The method as claimed in claim 23, wherein said one of confirming and issuing includes one of confirming the at least one port number as free and issuing the alternative port number by the network address translation unit,
wherein said method further comprises after said one of confirming and issuing
forwarding the one of the at least one port number and the alternative port number with an external network address from the network address translation unit to the configuration client; and
communicating the one of the at least one port number and the alternative port number with the external network address to the network service.

25. The method as claimed in claim 24, wherein said one of accepting and declining includes
one of accepting and declining the one of the at least one port number and the alternative port number by the network service;
forwarding an indication of the one of accepting and declining to the configuration server; and
if there is acceptance, communicating from the configuration server to the network address translation unit that the one of the at least one port number and the alternative port number is taken.

26. The method as claimed in claim 25, wherein said through-connecting of the incoming data traffic for the one of the at least one port number and the alternative port number includes marking the one of the at least one port number and the alternative port number as unavailable in the port number list.

27. The method as claimed in claim 26, wherein said requesting, confirming and one of accepting and rejecting is carried out according to the dynamic host configuration protocol.

28. The method as claimed in claim 27, wherein the network service is a Voice over Internet Protocol service.
